(19) United States
(12) Patent Application Publication
(10) Pub. No.: US 2024/0397417 A1
(43) Pub. Date: Nov. 28, 2024

(54) Methods, Network Nodes, and Computer Readable Media for Dynamically Discovering Serving Network Node in Core Network

(71) Applicant: Telefonaktiebolaget LM Ericsson (publ), Storholm (SE)

(72) Inventors: Qiang Liu, Shanghai (CN); Tianmei Liang, Shanghai (CN)

(21) Appl. No.: 18/272,637

(22) PCT Filed: Dec. 28, 2021
(86) PCT No.: PCT/CN2021/141905

§ 371 Date: Jul. 17, 2023

(30) Foreign Application Priority Data
Jan. 18, 2021 (WO) PCT/CN2021/072518

(51) Int. Cl. H04W 48/18; H04M 15/00; H04W 28/24; H04W 48/16

(52) U.S. Cl. CPC H04W 48/18; H04M 15/66; H04W 28/24; H04W 48/16

(57) ABSTRACT

The present disclosure provides methods, network nodes, and computer readable media for dynamically discovering a serving network node in a core network. The method at an NEF includes: receiving a service request message for the Ethernet type session from an AF, wherein the service request message comprises network related identification information for the Ethernet type session; and discovering, based on the network related identification information, a BSF that holds binding information of a PCF for the Ethernet type session.

### TECHNICAL FIELD

The present disclosure generally relates to the technical field of communication technologies, and particularly to methods, network nodes, and computer readable media for dynamically discovering a serving network node in a core network.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

Ethernet Type PDU Session in 5G network

Typical use cases of an Ethernet type PDU Session in 5G network includes, but not limited to, 5G Local Area Network (LAN) type services, Time Sensitive Network (TSN), etc.

As per 3GPP TS 22.261 v18.1.0, the 5G LAN type service may have different types of traffic:
1) traffic scenarios typically found in a home setting (from sensors to video streaming, relatively low amount of UEs per group, many devices are used only occasionally) for 5G LAN-type service;
2) traffic scenarios typically found in an office setting (from sensors to very high data rates e.g. for conferencing, medium amount of UEs per group) for 5G LAN-type service;
3) traffic scenarios typically found in an industrial setting (from sensors to remote control, large amount of UEs per group) for 5G LAN-type service.

FIGS. 1A and 1B are excerpted from 3GPP TS 23.501 v16.7.0, which schematically show user plane architectures to support 5G LAN-type services using local switch and using N19 tunnel, respectively.

For UEs within the same region, the local-switch based architecture as shown in FIG. 1A may be used to provide better Quality of Experience (QoE), together with the N19 based architecture as shown in FIG. 1B for communication with UEs in other regions.

### SUMMARY

As discussed in 3GPP TS 29.122 v17.0.0, 3^{rd} Generation Partnership Project (3GPP) network allows an Application Function (AF) to set up an Application Server (AS) Session with required Quality of Service (QoS) for service data flow(s) within an (Internet Protocol (IP) or Ethernet) type Packet Data Unit (PDU) session. In particular, for an untrusted AF, it is allowed to set up the AS session with required QoS via an Exposure Function like a Network Exposure Function (NEF). The AF request may contain a UE address (e.g., an IPv4, or IPv6, or Media Access Control (MAC) address), (IP or Ethernet) service data flow information, an IPv4 address domain identifier, a QoS reference identifier, and other attributes.

When the NEF receives such AF requests, the NEF needs to find a serving Policy Control Function (PCF) of the corresponding (IP or Ethernet) PDU Session, then interacts with the PCF via either Rx or Service Based Interface (SBI) to set up the required QoS.

For the IP type PDU Session, an IP address is allocated by the 5G Core (5GC) to the UE associated with the IP type PDU Session, and is received in the AF request. In order to be able to find the serving PCF in a dynamic way, the NEF first discoveries a Binding Support Function (BSF) via a Network Repository Function (NRF) by using the IP address as a query parameter. It is known that a BSF is corresponding to a range of IP addresses, and thus the NEF may query the NRF for the BSF by using the IP address received in the AF request. The BSF holds (PDU) session binding information of a PCF serving the corresponding IP type PDU Session. Thus, the NEF further queries the BSF to find (PDU) session binding information of the corresponding PCF by using the IP address (and optionally, the IPv4 address domain identifier). Then, the NEF may get the serving PCF address information in the session binding information, i.e., discover the serving PCF.

As specified in 3GPP TS 23.501 v16.7.0, for the Ethernet type PDU Session, neither an MAC address nor an IP address over the MAC address is allocated by the 5GC to the UE associated with the Ethernet type PDU session. Thus, the BSF is not aware which MAC addresses it can serve.

For the Ethernet type PDU Session, the current APIs at the NEF, such as AFsessionWithQoS, ChargeableParty, and other appropriate APIs, provide only an UE MAC address of the UE associated with the Ethernet type PDU Session, the Ethernet service data flow information (also called “Ethernet flow information” throughout the present disclosure), etc., these attributes of the Ethernet type PDU Session are not enough for the NEF to find the serving PCF in a dynamic way similar as for the IP type PDU session as previously described, especially the NEF is not able to find the right BSF via the NRF by using these attributes currently provided at the APIs, such as the UE MAC address, the Ethernet service data flow information. Currently, it is not defined how the NEF dynamically identifies/discovers the serving PCF of the corresponding Ethernet type PDU Session.

For example, when the NEF receives an Nnef_AFsessionWithQoS_Create service operation (with attributes, such as the UE MAC address, the Ethernet service data flow information, etc.) from the AF to set up QoS for service data flow(s) of an Ethernet type PDU Session, there is no way to discover the BSF (which holds (PDU) session binding information of the PCF serving the corresponding PDU Session) from the NRF by using an MAC address, since as previously described, neither an MAC address nor an IP address over the MAC address is allocated by the 5GC to the UE for the Ethernet type PDU session, and thus the BSF is not aware which MAC addresses it can serve. Accordingly, the NEF cannot dynamically discover the PCF serving the corresponding Ethernet type PDU Session.

In order to solve the above problems as described, embodiments of the present disclosure propose that the NEF exposes, to the AF, network related identification information, such as an external group identifier (ID), a Data Network Name (DNN) and/or a Single-Network Slice Selection Assistance Information (S-NSSAI) serving the Ethernet type PDU Session.

As such, the AF may request the corresponding service for the Ethernet type session with attributes, such as the UE MAC address for the UE associated with the Ethernet PDU type session, Ethernet service data flow information, etc., and the newly introduced external group ID, DNN and/or S-NSSAI. Accordingly, the NEF may use the UE MAC address, the external group ID, or DNN and/or S-NSSAI to dynamically discover the PCF serving the concerned Ethernet type PDU Session.

According to a first aspect of the present disclosure, a method at an AF for facilitating an NEF in a core network to dynamically discover a PCF serving an Ethernet type session. The method includes: transmitting a service request message for the Ethernet type session to the NEF, wherein the service request message includes network related identification information for the Ethernet type session.

In an exemplary embodiment, the network related identification information for the Ethernet type session is preconfigured in the AF or dynamically provided.

In an exemplary embodiment, the network related identification information for the Ethernet type session includes at least one of: a DNN for the Ethernet type session, and an S-NSSAI for the Ethernet type session.

In an exemplary embodiment, the service request message further includes a UE MAC address for a UE associated with the Ethernet type session.

In an exemplary embodiment, the method further includes: receiving, from the NEF, a response indicating whether a requested service is successfully invoked for the Ethernet type session or not.

In an exemplary embodiment, the service request message includes at least one of: a request message for managing required QoS for a service data flow of the Ethernet type session, and a request message for managing a chargeable party for the Ethernet type session.

According to a second aspect of the present disclosure, a method at an NEF in a core network for dynamically discovering a PCF for an Ethernet type session. The method includes: receiving a service request message for the Ethernet type session from an AF, wherein the service request message includes network related identification information for the Ethernet type session, and discovering, based on the network related identification information, a BSF that holds binding information of the PCF for the Ethernet type session.

In an exemplary embodiment, the service request message further includes a UE MAC address of a UE associated with the Ethernet type session.

In an exemplary embodiment, the method further includes: discovering the PCF using the UE MAC address received from the AF by querying the BSF.

In an exemplary embodiment, the method further includes: discovering the PCF based on the network related identification information.

In an exemplary embodiment, the network related identification information for the Ethernet type session is preconfigured in the AF or dynamically provided to the AF.

In an exemplary embodiment, the network related identification information for the Ethernet type session includes at least one of: a DNN for the Ethernet type session, and an S-NSSAI for the Ethernet type session.

In an exemplary embodiment, the BSF is discovered by the NEF querying a NRF using the at least one of the DNN for the Ethernet type session and the S-NSSAI for the Ethernet type session.

In an exemplary embodiment, the method further includes: transmitting, to the PCF, another service request message to invoke a requested service for the Ethernet type session, and receiving, from the PCF, a response indicating whether the requested service is successfully invoked for the Ethernet type session or not.

In an exemplary embodiment, the service request message includes a request message for managing required QoS for a service data flow of the Ethernet type session, and is received via an Nnef_AFsessionWithQoS API.

In an exemplary embodiment, the service request message includes a request message for managing a chargeable party for the Ethernet type session, and is received via an Nnef_ChargeableParty API.

According to a third aspect of the present disclosure, an AF is provided. The AF includes: at least one processor, and at least one memory, storing instructions which, when executed on the at least one processor, cause the AF to perform any of the methods according to the first aspect of the present disclosure.

According to a fourth aspect of the present disclosure, a NEF is provided. The NEF includes: at least one processor, and at least one memory, storing instructions which, when executed on the at least one processor, cause the NEF to perform any of the methods according to the second aspect of the present disclosure.

According to a fifth aspect of the present disclosure, a computer readable storage medium is provided. The computer readable storage medium has computer program instructions stored thereon, the computer program instructions, when executed by at least one processor, causing the at least one processor to perform the method according to any of the first and second aspects of the present disclosure.

The technical solutions of the embodiments of the present disclosure may enable the NEF in the core network to perform dynamic discovery of the PCF, serving the corresponding Ethernet type session via the NRF, and the BSF.

### BRIEF DESCRIPTION OF THE DRAWINGS

The objects, advantages and characteristics of the present disclosure will be more apparent, according to descriptions of preferred embodiments in connection with the drawings, in which:

FIG. 1A schematically shows a user plane architecture to support 5G LAN-type services using local switch;

FIG. 1B schematically shows a user plane architecture to support 5G LAN-type services using N19 tunnel;

FIG. 2 schematically shows a method at a first network node for facilitating a second network node in a core network to dynamically discover a third network node serving an Ethernet type session according to an exemplary embodiment of the present disclosure;

FIGS. 3A and 3B schematically show methods at a second network node in a core network for dynamically discovering a third network node for an Ethernet type session according to exemplary embodiments of the present disclosure;

FIG. 4 schematically shows an exemplary signaling sequence diagram of a procedure for setting up an AF session with required QoS, in which methods at the first network node and the second network node for dynamically discovering a third network node for an Ethernet type session according to exemplary embodiments of the present disclosure are applied;

FIG. 5 schematically shows an exemplary signaling sequence diagram of deriving a DNN and/or an S-NSSAI from an external group ID according to an exemplary embodiment of the present disclosure;

FIG. 6 schematically shows an exemplary signaling sequence diagram of a procedure for setting a chargeable party at session setup or during session, in which methods at the first network node and the second network node for dynamically discovering a third network node for an Ethernet type session according to exemplary embodiments of the present disclosure are applied;

FIG. 7 schematically shows a structural block diagram of a first network node according to an exemplary embodiment of the present disclosure;

FIG. 8 schematically shows a structural block diagram of a first network node according to another exemplary embodiment of the present disclosure;

FIG. 9 schematically shows a structural block diagram of a second network node according to an exemplary embodiment of the present disclosure; and

FIG. 10 schematically shows a structural block diagram of a second network node according to another exemplary embodiment of the present disclosure.

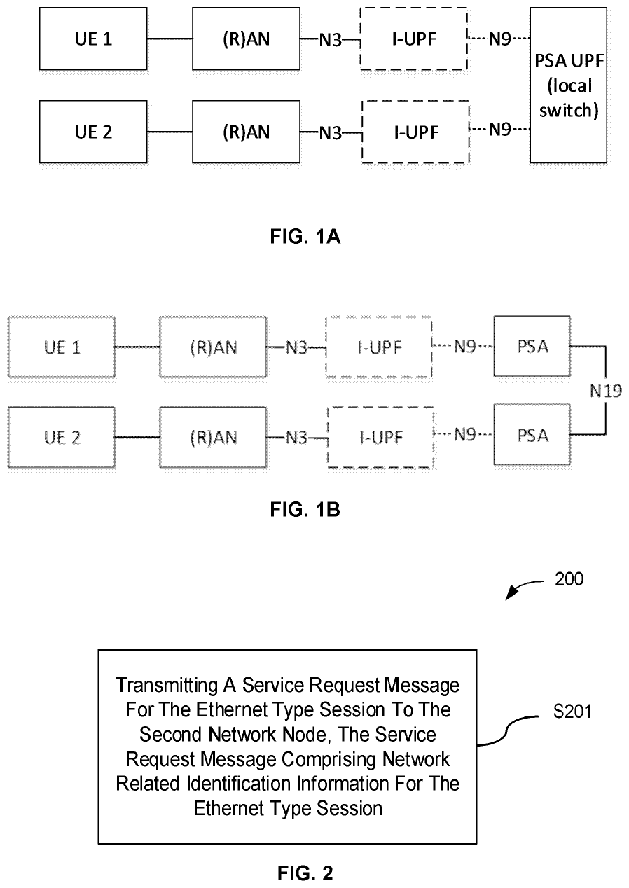

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

References in the specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terminology used herein is for the purpose of describing particular embodiments only and is not intended to be liming of exemplary embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “and/or” includes any and all combinations of one or more of the associated listed terms.

In the following description and claims, unless defined otherwise, all technical and scientific terms used herein have the same meaning as commonly understood by one of ordinary skills in the art to which this disclosure belongs. As used herein, the term “network” refers to a network following any suitable (wireless or wired) communication standards. For example, the wireless communication standards may comprise new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably.

Furthermore, the communications between two devices in the network may be performed according to any suitable communication protocols, including, but not limited to, the wireless communication protocols as defined by a standard organization such as 3GPP or the wired communication protocols. For example, the wireless communication protocols may comprise the first generation (1G), 2G, 3G, 4G, 4.5G, 5G communication protocols, and/or any other protocols either currently known or to be developed in the future.

The term “node” or “network node” used herein refers to a network device or network node or network function in a communication network, and may also refer to a virtualized entity that may be implemented on cloud. For example, in a wireless communication network such as a 3GPP-type cellular network, a core network device may offer numerous services to customers who are interconnected by an access network device. Each access network device is connectable to the core network device over a wired or wireless connection.

The term “CN network node” refers to any suitable function which can be implemented in a network node (physical or virtual) of a communication network. For example, a network node can be implemented either as a network element on a dedicated hardware, as a software instance running on a dedicated hardware, or as a virtualized function instantiated on an appropriate platform, e.g. on a cloud infrastructure. For example, the 5GC may comprise a plurality of functions such as AMF, Session Management Function (SMF), UDM, PCF, UPF (User plane Function), NRF, etc. For example, the 4G Core Network system (such as EPC) may include Mobility Management Entity (MME), HSS (Home Subscriber Server), Packet Data Network Gateway (PGW), Broadcast Multicast-Service Center (BM-SC), etc. In other embodiments, the CN network node may comprise different types of functions for example depending on the specific network.

The basic ideas of the present disclosure mainly consist in that
1) network related identification information for an Ethernet type session is included in a service request message of a first network node (e.g., an AF) towards a second network node (e.g., an NEF);
2) the second network node (e.g., the NEF) enhances its APIs such as AFsessionWithQoS, ChargeableParty, and other appropriate APIs, by exposing, to the first network node (e.g., the AF), new attributes, e.g., network related identification information, such as an external group ID, or a DNN and/or an S-NSSAI serving the Ethernet type session, in addition to the UE MAC address for the UE associated with the Ethernet PDU type session, Ethernet service data flow information, etc., so that the first network node (e.g., the AF) may request the corresponding service for the Ethernet type session with attributes, e.g., the network related identification information, such as the external group ID, DNN and/or S-NSSAI, in addition to e.g., the UE MAC address for the UE associated with the Ethernet PDU type session, Ethernet service data flow information, etc.; and the NEF may use e.g., the UE MAC address, the external group ID, or the DNN and/or the S-NSSAI to dynamically discover a third network node (e.g., an PCF) serving the Ethernet type session;
3) the second network node (e.g., the NEF) dynamically discovers a fifth network node (e.g., a BSF) via a sixth network node (e.g., an NRF) based on the DNN and/or the S-NSSAI, which may be directly received from the first network node (e.g., the AF) in the service request message, or derived from the external group ID in the received service request message by the second network node (e.g., the NEF) via querying a fourth network node (e.g., a UDM); and
4) the second network node (e.g., the NEF) queries the fifth network node (e.g., the BSF) for session binding information of the third network node (e.g., the PCF) serving the Ethernet type session using the UE MAC address, and the DNN and/or the S-NSSAI, and obtain address information of the serving third network node (e.g., the serving PCF) in the session binding information to dynamically discover the serving third network node (e.g., the serving PCF).

Hereinafter, a method 200 at a first network node (e.g., an AF) for facilitating a second network node (e.g., an NEF) in a core network to dynamically discover a third network node (e.g., a PCF) serving an Ethernet type session according to an exemplary embodiment of the present disclosure will be described with reference to FIG. 2. It should be understood that the first network node (e.g., the AF) may be any node that can be configured to perform the method 200 as described below, including a virtualized entity that may be implemented on cloud. It should be understood that the method 200 may be appropriately applied in 5GS, or other future developments.

As shown in FIG. 2, the method 200 may include step S201.

In step S201, the first network node (e.g., the AF) may invoke a service operation for the Ethernet type session from the second network node (e.g., the NEF) by transmitting a service request message for the Ethernet type session to the second network node (e.g., the NEF). The service request message includes network related identification information for the Ethernet type session.

The network related identification information for the Ethernet type session may be preconfigured to the first network node (e.g., the AF), or may be dynamically provided to the first network node (e.g., the AF) via signaling.

In an exemplary embodiment, the network related identification information for the Ethernet type session may include at least one of:
a DNN for the Ethernet type session; and
an S-NSSAI for the Ethernet type session.

Alternatively or additionally, the network related identification information for the Ethernet type session may include an external group ID of a Virtual Network (VN), e.g., 5G LAN-VN, for the Ethernet type session, which is associated with at least one of:
a DNN for the Ethernet type session; and
an S-NSSAI for the Ethernet type session.

The external group ID may indicate support of the first network node (e.g., the AF) for at least one of:
an external group ID feature,
an Ethernet Application Server (AS) session QoS feature, and
an Ethernet chargeable party feature.

It may be understood that in addition to the network related identification information, such as the external group ID, or the DNN and/or the S-NSSAI, as proposed in the exemplary embodiments of the present disclosure, the service request message may include a UE MAC address for a UE associated with the Ethernet type session, an Ethernet service data flow information, and other conventional attributes of the Ethernet type session.

After the first network node (e.g., the AF) transmits the service request message including the network related identification information to the second network node (e.g., the NEF) in step S201, and the second network node (e.g., the NEF) dynamically discover the third network node (e.g., the PCF) serving the Ethernet type session based on the network related identification information, the method 200 further include: receiving, from the second network node (e.g., the NEF), a response indicating whether the requested service is successfully invoked for the Ethernet type session or not.

In an exemplary embodiment, the service request message may include a request message for managing (e.g., creating, updating, revoking etc.) required QoS for a service data flow of the Ethernet type session, which is used by the first network node (e.g., the AF) to invoke/request Nnef_AFsessionWithQoS related service from the second network node (e.g., the NEF) via an Nnef_AFsessionWithQoS API. Accordingly, the external group ID in the service request message may indicate support of the first network node (e.g., the AF) for at least one of:
an external group ID (e.g., ExternalGroupId_5G) feature, and
an Ethernet AS session QoS (e.g., EthAsSessionQoS_5G) feature.

Alternatively or additionally, the service request message may include a request message for managing (e.g., creating, updating, etc.) a chargeable party for the Ethernet type session, which is used by the first network node (e.g., the AF) to invoke/request Nnef_ChargeableParty related service from the second network node (e.g., the NEF) via an Nnef_ChargeableParty API. Accordingly, the external group ID in the service request message may indicate support of the first network node (e.g., the AF) for at least one of:
an external group ID (e.g., ExternalGroupId_5G) feature, and
an Ethernet chargeable party (e.g., EthChgParty_5G) feature.

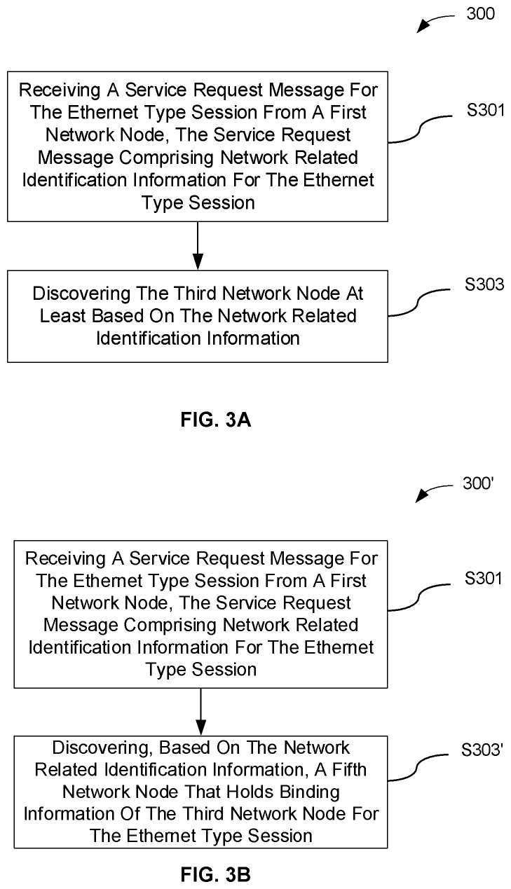

Hereinafter, a method 300 and a method 300′ at a second network node (e.g., an NEF) for dynamically discovering a third network node (e.g., a PCF) serving an Ethernet type session according to exemplary embodiments of the present disclosure will be described with reference to FIGS. 3A and 3B, respectively. It should be understood that the second network node (e.g., the NEF) may be any node that can be configured to perform the methods 300 and 300′ as described below, including a virtualized entity that may be implemented on cloud. It should be understood that the method 300 and 300′ may be appropriately applied in 5GS, or other future developments.

The methods 300 and 300′ at the second network node (e.g., the NEF) may correspond to the method 200 at the first network node (e.g., the AF), respectively. Thus, some description of the methods 300 and 300′ may refer to that of method 200, and thus will be omitted for simplicity.

As shown in FIG. 3A, the method 300 may include steps S301 and S303.

In step S301, the second network node (e.g., the NEF) may receive a service request message for the Ethernet type session from a first network node (e.g., an AF). The service request message includes network related identification information for the Ethernet type session.

Then in step S303, the second network node (e.g., the NEF) may discover the third network node (e.g., the PCF) at least based on the network related identification information.

As previously described, the network related identification information for the Ethernet type session may be preconfigured to the first network node (e.g., the AF), or may be dynamically provided to the first network node (e.g., the AF) via signaling.

In an exemplary embodiment, the network related identification information for the Ethernet type session may include at least one of:
a DNN for the Ethernet type session; and
an S-NSSAI for the Ethernet type session.

In this case, the second network node (e.g., the NEF) may obtain the DNN and/or the S-NSSAI for the Ethernet type session from the received network related identification information.

Alternatively or additionally, the network related identification information for the Ethernet type session may include an external group ID of a Virtual Network (VN), e.g., 5G LAN-VN, for the Ethernet type session, which is associated with at least one of:
a DNN for the Ethernet type session; and
an S-NSSAI for the Ethernet type session.

In this case, the second network node (e.g., the NEF) may derive the DNN and/or the S-NSSAI for the Ethernet type session from the external group ID in the received network related identification information.

In an exemplary embodiment, the DNN and/or the S-NSSAI for the Ethernet type session may be derived by the second network node (e.g., the NEF) querying a fourth network node (e.g., a UDM), that stores an association relationship between an external group ID and an DNN and/or S-NSSAI, for the at least one of the DNN for the Ethernet type session and the S-NSSAI for the Ethernet type session, using the external group ID.

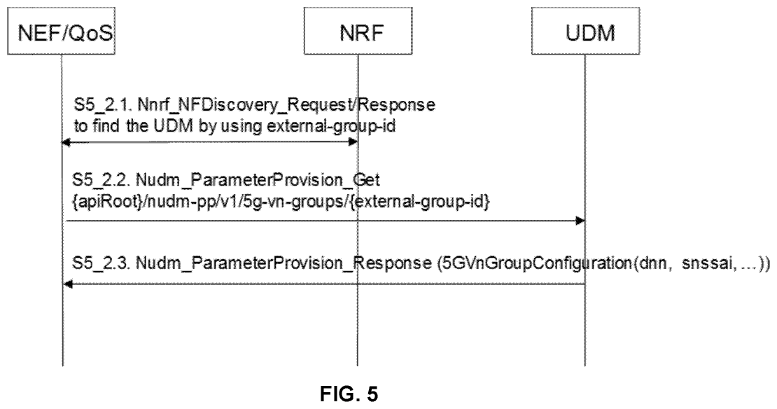

In particular, the second network node (e.g., the NEF) may query a sixth network node (e.g., an NRF) to find the fourth network node (e.g., the UDM) using the external group ID; and then query the fourth network node (e.g., the UDM) for the at least one of the DNN for the Ethernet type session and the S-NSSAI for the Ethernet type session, using the external group ID, which will be exemplarily described in conjunction with FIG. 5 later.

As previously described, the external group ID may indicate support of the first network node (e.g., the AF) for at least one of:
an external group ID feature,
an Ethernet Application Server (AS) session QoS feature, and
an Ethernet chargeable party feature.

It may be understood that in addition to the network related identification information, such as the external group ID, or the DNN and/or the S-NSSAI, as proposed in the exemplary embodiments of the present disclosure, the service request message may include a UE MAC address for a UE associated with the Ethernet type session, an Ethernet service data flow information, and other conventional attributes of the Ethernet type session.

In another exemplary embodiment as shown in FIG. 3B, the method 300′ may include step S301 same as that in FIG. 3A (thus description thereof will be omitted here for simplicity), and step S303′ instead. The step S303′ may include: discovering, based on the network related identification information, a fifth network node (e.g., a BSF) that holds binding information of the third network node (e.g., the PCF) for the Ethernet type session. Then, the second network node (e.g., the NEF) may discover the third network node (e.g., the PCF) using the UE MAC address received from the first network node (e.g., the AF) by querying the fifth network node (e.g., the BSF).

In particular, the fifth network node (e.g., the BSF) may be discovered by the second network node (e.g., the NEF) querying the sixth network node (e.g., the NRF) using the at least one of the DNN for the Ethernet type session and the S-NSSAI for the Ethernet type session.

After step S303 in FIG. 3A or step S303′ in FIG. 3B, the second network node (e.g., the NEF) may transmit, to the third network node (e.g., the PCF), another service request message to invoke a requested service for the Ethernet type session; and receive, from the third network node (e.g., the PCF), a response indicating whether the requested service is successfully invoked for the Ethernet type session or not.

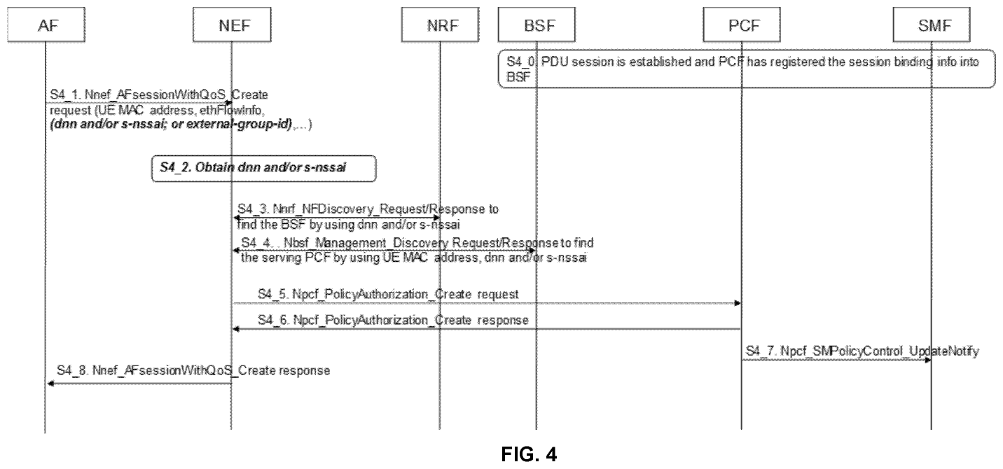

In an exemplary embodiment, the service request message may include a request message for managing (e.g., creating, updating, revoking/deleting etc.) required QoS for a service data flow of the Ethernet type session, which is received by the second network node (e.g., the NEF) via an Nnef_AFsessionWithQoS API, in order to provide Nnef_AFsessionWithQoS related service to the requesting first network node (e.g., the requesting AF), which will be exemplarily described in conjunction with FIG. 4 later. Accordingly, the external group ID in the service request message may indicate support of the first network node (e.g., the AF) for at least one of:
an external group ID (e.g., ExternalGroupId_5G) feature, and
an Ethernet AS session QoS (e.g., EthAsSessionQoS_5G) feature.

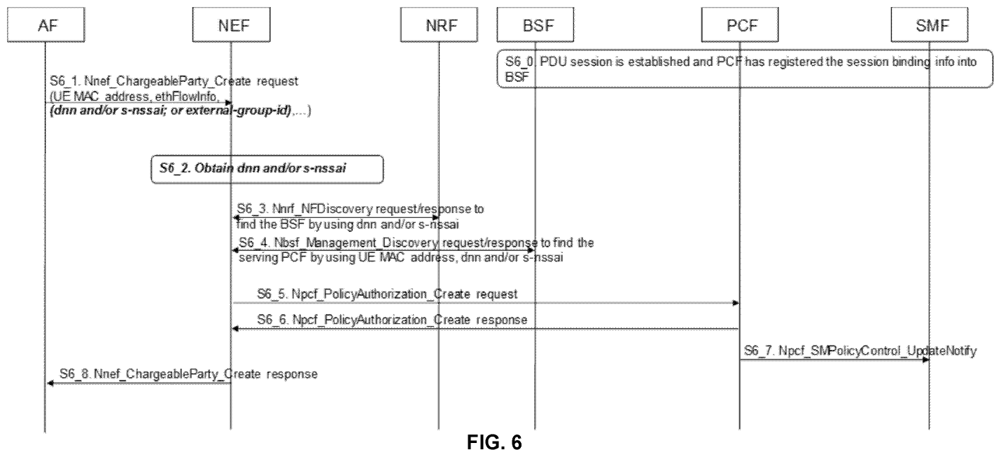

Alternatively or additionally, the service request message may include a request message for managing (e.g., creating, updating, etc.) a chargeable party for the Ethernet type session, which is received by the second network node (e.g., the NEF) via an Nnef_ChargeableParty API, in order to provide Nnef_ChargeableParty related service to the requesting first network node (e.g., the requesting AF), which will be exemplarily described in conjunction with FIG. 6 later. Accordingly, the external group ID in the service request message may indicate support of the first network node (e.g., the AF) for at least one of: an external group ID (e.g., ExternalGroupId_5G) feature, and an Ethernet chargeable party (e.g., EthChgParty_5G) feature.

Hereinafter, an exemplary signaling sequence diagram of a procedure for setting up an AF session with required QoS will be described with reference to FIG. 4, in which the method 200 at the first network node for facilitating the second network node to dynamically discover the serving third network node and the method 300 at the second network node for dynamically discovering the serving third network node according to exemplary embodiments of the present disclosure are applied.

It should be noted that the description below mainly focuses on signaling related to the methods 200 and 300, and some other signaling is not described in detail to avoid obscuring the principle of the present disclosure. In FIG. 4, modification on the signaling related to the methods 200 and 300 is shown in Bold Italics, in which Signaling S4_1 and S4_2 are involved.

The procedure of FIG. 4 occurs when the Ethernet type PDU session is established, and the PCF (an example of the third network node as previously described) has registered the session binding information into the BSF (an example of the fifth network node as previously described), which is denoted as S4_0.

In S4_1, the AF (an example of the first network node as previously described) invokes an Nnef_AFSessionWithQoS_Create service operation by transmitting to the NEF (an example of the second network node as previously described) a service request message, e.g., an Nnef_AFSessionWithQoS_Create request message with an UE MAC address of the UE associated with the Ethernet type PDU session, Ethernet service data flow information (represented as ethFlowInfo) of the Ethernet type PDU session, and other attributes of the Ethernet type PDU session. In addition to the UE MAC address, ethFlowInfo, and other attributes, the service request message may further include network related identification information of the Ethernet type PDU session, such as an external group ID of the corresponding 5G LAN-VN group, or a DNN and/or an S-NSSAI for the Ethernet type PDU session.

It should be understood that although Nnef_AFSessionWithQoS_Create is exemplarily illustrated in FIG. 4, the present disclosure is also applicable to Nnef_AFSessionWithQoS_Update/Revoke.

The Nnef_AFSessionWithQoS_Create request may be an HTTP POST request.

In S4_2, the NEF obtains the DNN and/or the S-NSSAI of the corresponding 5G LAN-VN group from the service request message received from the AF.

In an exemplary embodiment, the service request message includes the DNN and/or the S-NSSAI, which can be used directly.

In another exemplary embodiment, the service request message includes the external group ID of the corresponding 5G LAN-VN group. In this case, the NEF needs to map the external group ID to the DNN and/or the S-NSSAI by querying a UDM, that stores an association relationship between the external group ID and the DNN and/or the S-NSSAI, for the DNN and/or the S-NSSAI, using the external group ID, in order to derive the DNN and/or the S-NSSAI from the external group ID in the received service request message.

Turning to FIG. 5, FIG. 5 schematically shows an exemplary signaling sequence diagram of deriving the DNN and/or the S-NSSAI from the external group ID according to an exemplary embodiment of the present disclosure.

In S5_2.1, the NEF may query the NRF (an example of the sixth network node example of t) by Nnrf_NFDiscovery_Request to find the UDM (an example of the fourth network node as previously described) using the external group ID as the query parameter.

Next in S5_2.2, the NEF may query the UDM by Nudm_ParameterProvision_Get for the DNN and/or the S-NSSAI using the external group ID as the query parameter.

Then in S5_2.3, the NEF may receive, from the UDM, the DNN and/or the S-NSSAI by Nudm_ParameterProvision_Response.

Now turning back to FIG. 4, after the NEF obtains the DNN and/or the S-NSSAI in S4_2, the NEF may query the NRF by Nnrf_NFDiscovery_Request to dynamically discover the BSF using the DNN and/or the S-NSSAI as query parameters in S4_3.

In S4_4, the NEF may query the BSF discovered in S4_3 by Nbsf_Management_Discovery_Request to dynamically discover the serving PCF of the corresponding Ethernet type PDU session using the UE MAC address, the DNN and/or the S-NSSAI as query parameters.

In S4_5, the NEF may transmit, to the serving PCF, a policy authorization related service request message by e.g., Npcf_PolicAuthorization_Create request to invoke a policy authorization related service.

The Npcf_PolicAuthorization_Create request may be an HTTP POST request.

In S4_6, the serving PCF may transmit, to the NEF, a policy authorization related service response message by e.g., Npcf_PolicAuthorization_Create response to indicate the result of the policy authorization related service invocation.

It should be understood that although Npcf_PolicAuthorization_Create is exemplarily illustrated in FIG. 4, the present disclosure is also applicable to Npcf_PolicAuthorization_Update/Delete.

In S4_7, the serving PCF may invoke the Npcf_SMPolicyControl_UpdateNotify service operation with possibly updated policy information about the Ethernet type PDU session.

In S4_8, the NEF may transmit, to the AF, a response message by e.g., Nnef_AFSessionWithQoS_Create response to indicate the invocation result of the requested service.

The exemplary procedure as shown in FIG. 4 relates to modifications on e.g., following sections in 3GPP TS 29.122 v17.0.0, which are shown in Bold.
Modifications on DNN and S-NSSAI in AsSessionWithQoS API in 3GPP TS 29.122 v17.0.0
   ***1st Change***

### 5.14.2.1.1 Introduction

This clause defines data structures to be used in resource representations, including subscription resources.

Table 5.14.2.1.1-1 specifies data types re-used by the AsSessionWithQoS API from other specifications, including a reference to their respective specifications and when needed, a short description of their use within the AsSessionWithQoS API.

TABLE 5.14.2.1.1-1
AsSessionWithQoS API re-used Data Types

| Data type | Reference | Comments |
|---|---|---|
| Dnn | 3GPP TS 29.571 [45] | Identifies a DNN. |
| EthFlowDescription | 3GPP TS 29.514 [52] | Defines a packet filter for an Ethernet |
| | | flow.(NOTE 1) |
| MacAddr48 | 3GPP TS 29.571 [45] | MAC Address. |
| ReportingFrequency | 3GPP TS 29.512 [8] | Indicates the frequency for the reporting, |
| | | such as event triggered, periodic, when |
| | | the PDU Session is released, and/or any |
| | | combination. (NOTE 2) |
| RequestedQosMonitoringParameter | 3GPP TS 29.512 [8] | Indicate the UL packet delay, DL packet |
| | | delay or round trip packet delay between |
| | | the UE and the UPF is to be monitored |
| | | when the QoS Monitoring for URLLC is |
| | | enabled for the service data flow. |
| | | (NOTE 2) |
| Snssai | 3GPP TS 29.571 [45] | Identifies the S-NSSAI. |
| SupportedFeatures | 3GPP TS 29.571 [45] | Used to negotiate the applicability of the |
| | | optional features defined in table 5.14.4-1. |

(NOTE 1)
In order to support a set of MAC addresses with a specific range in the traffic filter, feature MacAddressRange_5G as specified in clause 5.14.4 shall be supported.
(NOTE 2):
In order to support QoS Monitoring, feature QoSMonitoring_5G as specified in clause 5.14.4 shall be supported.

***2nd Change***

### 5.14.2.1.2 Type: AsSessionWithQoSSubscription

This type represents an AS session request with specific QoS for the service provided by the SCS/AS to the SCEF via T8 interface. The structure is used for subscription request and response.

TABLE 5.14.2.1.2-1
Definition of type AsSessionWithQoSSubscription

| Attribute name | Data type | Cardinality | Description | Applicability (NOTE 1) |
|---|---|---|---|---|
| self | Link | 0 . . . 1 | Link to the resource “Individual AS | |
| | | | Session with Required QoS | |
| | | | Subscription”. | |
| | | | This parameter shall be supplied by | |
| | | | the SCEF in HTTP responses. | |
| supportedFeatures | SupportedFeatures | 0 . . . 1 | Used to negotiate the supported | |
| | | | optional features of the API as | |
| | | | described in subclause 5.2.7. | |
| | | | This attribute shall be provided in the | |
| | | | POST request and in the response | |
| | | | of successful resource creation. | |
| dnn | Dnn | 0 . . . 1 | Identifies a DNN, a full DNN with | EthAsSessionQoS_{—}5G |
| | | | both the Network Identifier and | |
| | | | Operator Identifier, or a DNN with | |
| | | | the Network Identifier only. | |
| snssai | Snssai | 0 . . . 1 | Identifies an S-NSSAI. | EthAsSessionQoS_{—}5G |
| notificationDestination | Link | 1 | Contains the URL to receive the | |
| | | | notification bearer level event(s) from | |
| | | | the SCEF. | |
| flowInfo | array(FlowInfo) | 0 . . . N | Describe the IP data flow which | |
| | | | requires QoS. | |
| | | | (NOTE 2) | |
| ethFlowInfo | array(EthFlowDescription) | 0 . . . N | Identifies Ethernet packet flows. | EthAsSessionQoS_5G |
| | | | (NOTE 2) | |
| qosReference | string | 0 . . . 1 | Identifies a pre-defined QoS | |
| | | | information | |
| altQoSReferences | array(string) | 0 . . . N | Identifies an ordered list of pre- | AlternativeQoS_5G |
| | | | defined QoS information. The lower | |
| | | | the index of the array for a given | |
| | | | entry, the higher the priority. | |
| ueIpv4Addr | Ipv4Addr | 0 . . . 1 | The Ipv4 address of the UE. | |
| | | | (NOTE 2) | |
| ipDomain | string | 0 . . . 1 | The IPv4 address domain identifier. | |
| | | | The attribute may only be provided if | |
| | | | the ueIpv4Addr attribute is present. | |
| ueIpv6Addr | Ipv6Addr | 0 . . . 1 | The Ipv6 address of the UE. | |
| | | | (NOTE 2) | |
| macAddr | MacAddr48 | 0 . . . 1 | Identifies the MAC address. | EthAsSessionQoS_5G |
| | | | (NOTE 2) | |
| usageThreshold | UsageThreshold | 0 . . . 1 | Time period and/or traffic volume in | |
| | | | which the QoS is to be applied. | |
| sponsorInfo | SponsorInformation | 0 . . . 1 | Indicates a sponsor information | |
| qosMonInfo | QosMonitoringInformation | 0 . . . 1 | Qos Monitoring information. It can be | QoSMonitoring_5G |
| | | | present when the event | |
| | | | “QOS_MONITORING” is subscribed. | |
| requestTestNotification | boolean | 0 . . . 1 | Set to true by the SCS/AS to request | Notification_test_event |
| | | | the SCEF to send a test notification | |
| | | | as defined in subclause 5.2.5.3. Set | |
| | | | to false or omitted otherwise. | |
| websockNotifConfig | WebsockNotifConfig | 0 . . . 1 | Configuration parameters to set up | Notification_websocket |
| | | | notification delivery over Websocket | |
| | | | protocol as defined in | |
| | | | subclause 5.2.5.4. | |

(NOTE 1):
Properties marked with a feature as defined in subclause 5.14.4 are applicable as described in subclause 5.2.7. If no features are indicated, the related property applies for all the features.
(NOTE 2):
One of “ueIpv4Addr”, “ueIpv6Addr” or “macAddr” shall be included. If ipv4 or ipv6 address is provided, IP flow information shall be provided. If MAC address is provided, Ethernet flow information shall be provided.

### ***End of Changes***

Modifications on External Group ID in AsSessionWithoS API in 3GPP TS 29.122 v17.0.0
   ***1st Change***

### 5.14.2.1.2 Type: AsSessionWithSoSSubsSription

This type represents an AS session request with specific QoS for the service provided by the SCS/AS to the SCEF via T8 interface. The structure is used for subscription request and response.

TABLE 5.14.2.1.2-1
Definition of type AsSessionWithQoSSubscription

| Attribute name | Data type | Cardinality | Description | Applicability (NOTE 1) |
|---|---|---|---|---|
| self | Link | 0 . . . 1 | Link to the resource “Individual AS Session | |
| | | | with Required QoS Subscription”. | |
| | | | This parameter shall be supplied by the | |
| | | | SCEF in HTTP responses. | |
| externalGroupId | ExternalGroupId | 0 . . . 1 | Identifies a user group. For a Create | EthAsSessionQoS_{—}5G |
| | | | request associated with a 5G VN group, | ExternalGroupId_{—}5G |
| | | | the External Group ID identifies the 5G | |
| | | | VN Group. | |
| supportedFeatures | SupportedFeatures | 0 . . . 1 | Used to negotiate the supported optional | |
| | | | features of the API as described in | |
| | | | subclause 5.2.7. | |
| | | | This attribute shall be provided in the POST | |
| | | | request and in the response of successful | |
| | | | resource creation. | |
| dnn | Dnn | 0 . . . 1 | Identifies a DNN, a full DNN with both the | EthAsSessionQoS_5G |
| | | | Network Identifier and Operator Identifier, or | |
| | | | a DNN with the Network Identifier only. | |
| snssai | Snssai | 0 . . . 1 | Identifies an S-NSSAI. | EthAsSessionQoS_5G |
| notificationDestination | Link | 1 | Contains the URL to receive the notification | |
| | | | bearer level event(s) from the SCEF. | |
| flowInfo | array(FlowInfo) | 0 . . . N | Describe the IP data flow which requires | |
| | | | QoS. | |
| | | | (NOTE 2) | |
| ethFlowInfo | array(EthFlowDescription) | 0 . . . N | Identifies Ethernet packet flows. | EthAsSessionQoS_5G |
| | | | (NOTE 2) | |
| qosReference | string | 0 . . . 1 | Identifies a pre-defined QoS information | |
| altQoSReferences | array(string) | 0 . . . N | Identifies an ordered list of pre-defined QoS | AlternativeQoS_5G |
| | | | information. The lower the index of the array | |
| | | | for a given entry, the higher the priority. | |
| ueIpv4Addr | Ipv4Addr | 0 . . . 1 | The Ipv4 address of the UE. | |
| | | | (NOTE 2) | |
| ipDomain | string | 0 . . . 1 | The IPv4 address domain identifier. | |
| | | | The attribute may only be provided if the | |
| | | | ueIpv4Addr attribute is present. | |
| ueIpv6Addr | Ipv6Addr | 0 . . . 1 | The Ipv6 address of the UE. | |
| | | | (NOTE 2) | |
| macAddr | MacAddr48 | 0 . . . 1 | Identifies the MAC address. | EthAsSessionQoS_5G |
| | | | (NOTE 2) | |
| usageThreshold | UsageThreshold | 0 . . . 1 | Time period and/or traffic volume in which | |
| | | | the QoS is to be applied. | |
| sponsorInfo | SponsorInformation | 0 . . . 1 | Indicates a sponsor information | |
| qosMonInfo | QosMonitoringInformation | 0 . . . 1 | Qos Monitoring information. It can be | QoSMonitoring_5G |
| | | | present when the event | |
| | | | “QOS_MONITORING” is subscribed. | |
| requestTestNotification | boolean | 0 . . . 1 | Set to true by the SCS/AS to request the | Notification_test_event |
| | | | SCEF to send a test notification as defined | |
| | | | in subclause 5.2.5.3. Set to false or omitted | |
| | | | otherwise. | |
| websockNotifConfig | WebsockNotifConfig | 0 . . . 1 | Configuration parameters to set up | Notification_websocket |
| | | | notification delivery over Websocket | |
| | | | protocol as defined in subclause 5.2.5.4. | |

(NOTE 1):
Properties marked with a feature as defined in subclause 5.14.4 are applicable as described in subclause 5.2.7. If no features are indicated, the related property applies for all the features.
(NOTE 2):
One of “ueIpv4Addr”, “ueIpv6Addr” or “macAddr” shall be included. If ipv4 or ipv6 address is provided, IP flow information shall be provided. If MAC address is provided, Ethernet flow information shall be provided.

***2nd Change***

### 5.14.4 Used Features

The table below defines the features applicable to the AsSessionWithQoS API. Those features are negotiated as described in subclause 5.2.7.

TABLE 5.14.4-1
Features used by AsSessionWithQoS API

| Feature | | |
|---|---|---|
| Number | Feature | Description |
| 1 | Notification_websocket | The delivery of notifications over Websocket is supported |
| | | according to subclause 5.2.5.4. This feature requires that the |
| | | Notification_test_event featute is also supported. |
| 2 | Notification_test_event | The testing of notifications connections is supported |
| | | according to subclause 5.2.5.3. |
| 3 | EthAsSessionQoS_5G | Setting up required QoS for Ethernet UE. This feature may |
| | | only be supported in 5G. |
| 4 | MacAddressRange_5G | Indicates the support of a set of MAC addresses with a |
| | | specific range in the traffic filter. This feature may only be |
| | | supported in 5G. |
| 5 | AlternativeQoS_5G | Indicates the support of alternative QoS requirements and the |
| | | QoS notification (i.e. whether the QoS targets for SDF(s) are |
| | | not guaranteed or guaranteed again). This feature may only |
| | | be supported in 5G. |
| 6 | QoSMonitoring_5G | Indicates the support of QoS Monitoring. This feature may |
| | | only be supported in 5G. |
| 7 | ExternalGroupId_{—}5G | Indicates the support of the External Group ID. Identifies |
| | | a user group. For a Create request associated with a 5G |
| | | VN group, the External Group ID identifies the 5G VN |
| | | Group. This feature may only be supported in 5G. |

Feature: A short name that can be used to refer to the bit and to the feature, e.g. “Notification”.
Description: A clear textual description of the feature.

### ***End of Changes***

The exemplary procedure as shown in FIG. 4 also relates to modifications on e.g., following sections in 3GPP TS 29.522 v17.0.0, which are shown in Bold.
Modifications on DNN and S-NSSAI in AsSessionWithQoS API procedure in 3GPP TS 29.522 v17.0.0
   ***1st Change***
   4.4.9 Procedures for Setting Up an AF Session with Required QoS

The procedures for setting up an AF session with required QoS in 5GS are described in subclause 4.4.13 of 3GPP TS 29.122 [4] with the following differences:
description of the SCS/AS applies to the AF;
description of the SCEF applies to the NEF;
description of the PCRF applies to the PCF;
the NEF may interact with BSF by using Nbsf_Management_Discovery service as defined in 3GPP TS 29.521 [9] to retrieve the PCF address;
the NEF shall interact with the PCF by using Npcf_PolicyAuthorization service as defined in 3GPP TS 29.514 [7];
if the EthAsSessionQoS_5G feature as defined in subclause 5.14.4 of 3GPP TS 29.122 [4] is supported and the request is for Ethernet UE:
   in the HTTP POST/PUT request, the AF shall include the UE MAC address within the “macAddr” attribute instead of the UE IP address and the Ethernet Flow description within the “ethFlowInfo” attribute instead of the IP Flow description; the AF may include the Ethernet UE corresponding “dnn” attribute and/or “snssai” attribute;
   in the HTTP PATCH request, the AF may update the Ethernet Flow description within the “ethFlowInfo” attribute;
if the “QoSMonitoring_5G” feature as defined in subclause 5.14.4 of 3GPP TS 29.122 [4] is supported, in order to support the QoS Monitoring, the AF shall include “qosMonInfo” attribute. Within the QosMonitoringInformation data structure, the AF shall include:
   one or more requested QoS Monitoring Parameter(s) within the “reqQosMonParams”; and
   one or more report frequency within the “repFreqs” attribute; and
   when the “repFreqs” attribute includes the value “PERIODIC”, the reporting period within the “repPeriod” attribute; and
   when the “repFreqs” attribute includes the value “EVENT_TRIGGERED”, the AF shall include:
      the delay threshold for downlink with the “repThreshDl” attribute;
      the delay threshold for uplink with the “repThreshUl” attribute; and/or
      the delay threshold for round trip with the “repThreshRp” attribute; and
      the minimum waiting time between subsequent reports within the “waitTime” attribute.
   when the NEF receives the event notification as defined in subclause 4.2.2 of 3GPP TS 29.508 [26] or subclause 4.2.5.14 of 3GPP TS 29.514 [7], the NEF shall include one or more QoS monitoring reports within the “qosMonReports” attribute. Within the QosMonitoringReport data structure, the NEF shall include:
      one or two uplink packet delays within the “ulDelays” attribute;
      one or two downlink packet delays within the “dlDelays” attribute; and/or
      one or two round trip packet delays within the “rtDelays” attribute; and
   if the “AlternativeQoS_5G” feature is supported, the AF may include an ordered list of QoS references within the “altQosReferences” attribute. The NEF shall transfer them to the PCF in the Npcf_PolicyAuthorization service. The NEF shall also subscribe to PCF events “QOS_NOTIF” and “SUCCESSFUL_RESOURCES_ALLOCATION” in the Npcf_PolicyAuthorization service. When the NEF receives the notification of PCF event “QOS_NOTIF”, it shall notify the AF with “QOS_GUARANTEED” event; or “QOS_NOT_GUARANTEED” event with the currently applied QoS reference or the indication that the lowest priority Alternative QoS parameter set cannot be fulfilled. When the NEF receives the notification of PCF event “SUCCESSFUL_RESOURCES_ALLOCATION”, it shall notify the AF the event together with the currently applied QoS reference if received.
NOTE: Based on the operator configuration, the QoS reference identifiers received from the AF can be the same or different as the QoS reference identifiers known at the PCF. The NEF can perform a mapping for the QoS reference identifier.

### ***End of Changes***

Modifications on External Group ID in AsSessionWithQoS API procedure in 3GPP TS 29.522 v17.0.0
   ***1st Change***
   4.4.9 Procedures for Setting Up an AF Session with Required QoS

The procedures for setting up an AF session with required QoS in 5GS are described in subclause 4.4.13 of 3GPP TS 29.122 [4] with the following differences:
description of the SCS/AS applies to the AF;
description of the SCEF applies to the NEF;
description of the PCRF applies to the PCF;
the NEF may interact with BSF by using Nbsf_Management_Discovery service as defined in 3GPP TS 29.521 [9] to retrieve the PCF address;
the NEF shall interact with the PCF by using Npcf_PolicyAuthorization service as defined in 3GPP TS 29.514 [7];
if the EthAsSessionQoS_5G feature as defined in subclause 5.14.4 of 3GPP TS 29.122 [4] is supported and the request is for Ethernet UE:
   in the HTTP POST/PUT request, the AF shall include the UE MAC address within the “macAddr” attribute instead of the UE IP address and the Ethernet Flow description within the “ethFlowInfo” attribute instead of the IP Flow description;
   in the HTTP POST/PUT request, the AF may include the Ethernet UE corresponding “externalGroupId” attribute, if the ExternalGroupId_5G feature is also supported.
   in the HTTP PATCH request, the AF may update the Ethernet Flow description within the “ethFlowInfo” attribute;
if the “QoSMonitoring_5G” feature as defined in subclause 5.14.4 of 3GPP TS 29.122 [4] is supported, in order to support the QoS Monitoring, the AF shall include “qosMonInfo” attribute. Within the QosMonitoringInformation data structure, the AF shall include:
   one or more requested QoS Monitoring Parameter(s) within the “reqQosMonParams”; and
   one or more report frequency within the “repFreqs” attribute; and
   when the “repFreqs” attribute includes the value “PERIODIC”, the reporting period within the “repPeriod” attribute; and
   when the “repFreqs” attribute includes the value “EVENT_TRIGGERED”, the AF shall include:
      the delay threshold for downlink with the “repThreshDl” attribute;
      the delay threshold for uplink with the “repThreshUl” attribute; and/or
      the delay threshold for round trip with the “repThreshRp” attribute; and
      the minimum waiting time between subsequent reports within the “waitTime” attribute.
   when the NEF receives the event notification as defined in subclause 4.2.2 of 3GPP TS 29.508 [26] or subclause 4.2.5.14 of 3GPP TS 29.514 [7], the NEF shall include one or more QoS monitoring reports within the “qosMonReports” attribute. Within the QosMonitoringReport data structure, the NEF shall include:
      one or two uplink packet delays within the “ulDelays” attribute;
      one or two downlink packet delays within the “dlDelays” attribute;
      and/or
      one or two round trip packet delays within the “rtDelays” attribute; and
   if the “AlternativeQoS_5G” feature is supported, the AF may include an ordered list of QoS references within the “altQosReferences” attribute. The NEF shall transfer them to the PCF in the Npcf_PolicyAuthorization service. The NEF shall also subscribe to PCF events “QOS_NOTIF” and “SUCCESSFUL_RESOURCES_ALLOCATION” in the Npcf_PolicyAuthorization service. When the NEF receives the notification of PCF event “QOS_NOTIF”, it shall notify the AF with “QOS_GUARANTEED” event; or “QOS_NOT_GUARANTEED” event with the currently applied QoS reference or the indication that the lowest priority Alternative QoS parameter set cannot be fulfilled. When the NEF receives the notification of PCF event “SUCCESSFUL_RESOURCES_ALLOCATION”, it shall notify the AF the event together with the currently applied QoS reference if received.
NOTE: Based on the operator configuration, the QoS reference identifiers received from the AF can be the same or different as the QoS reference identifiers known at the PCF. The NEF can perform a mapping for the QoS reference identifier.

### ***End of Changes***

Hereinafter, FIG. 6 schematically shows an exemplary signaling sequence diagram of a procedure for setting a chargeable party at session setup or during session, in which the method 200 at the first network node for facilitating the second network node to dynamically discover the serving third network node and the method 300 at the second network node for dynamically discovering the serving third network node according to exemplary embodiments of the present disclosure are applied.

As previously described, the embodiments of the present disclosure may be applicable to the Nnef_AFsessionWithQoS API, and may also be applicable to the Nnef_ChargeableParty API at the NEF. The procedure of FIG. 6 is identical with that of FIG. 4 except the first Signaling S6_1. Therefore, the description of S6_0 and S6_2-S6_8 may refer to the previous description of S4_0 and S4_2-S4_8, which thus will be omitted here for simplicity. Hereinafter, S6_1 will be described for illustrating the difference between the procedures of FIG. 6 and FIG. 4.

In S6_1, the AF (an example of the first network node as previously described) invokes an Nnef_ChargeableParty_Create service operation by transmitting to the NEF (an example of the second network node as previously described) a service request message with an UE MAC address of the UE associated with the Ethernet type PDU session, Ethernet service data flow information (represented as ethFlowInfo) of the Ethernet type PDU session, and other attributes of the Ethernet type PDU session. In addition to the UE MAC address, ethFlowInfo, and other attributes, the service request message may further include network related identification information of the Ethernet type PDU session, such as an external group ID of the corresponding 5G LAN-VN group, or a DNN and/or an S-NSSAI for the Ethernet type PDU session.

It should be understood that although Nnef_ChargeableParty_Create is exemplarily illustrated in FIG. 6, the present disclosure is also applicable to Nnef_ChargeableParty_Update.

The exemplary procedure as shown in FIG. 6 relates to modifications on e.g., following sections in 3GPP TS 29.122 v17.0.0, which are shown in Bold.
Modifications on DNN and S-NSSAI in ChargeableParty API in 3GPP TS 29.122 v17.0.0
   ***1st Change***

### 3.2 Abbreviations

For the purposes of the present document, the abbreviations given in 3GPP TR 21.905 [1] and the following apply. An abbreviation defined in the present document takes precedence over the definition of the same abbreviation, if any, in 3GPP TR 21.905 [1].
AF Application Function
AS Application Server
ASP Application Service Provider
BDT Background Data Transfer
CAPIF Common API Framework
CP Communication Pattern
DDN Downlink Data Notification
DNN Data Network Name
DL Downlink
eNB Evolved Node B
GMD Group Message Delivery
IMEI-TAC Type Allocation Code part of an IMEI
IWK-SCEF Interworking SCEF
JSON JavaScript Object Notation
MIME Multipurpose Internet Mail Extensions
MT Mobile Terminated
MTC Machine Type Communications
MT-LR Mobile Terminated Location Request
NEF Network Exposure Function
NIDD Non-IP Data Delivery
NP Network Parameter
PCRF Policy and Charging Rule Function
PDN Packet Data Network
PFD Packet Flow Description
PFDF Packet Flow Description Function
RCAF RAN Congestion Awareness Function
REST Representational State Transfer
SACH Service Announcement Channel
SCEF Service Capability Exposure Function
SCS Services Capability Server
S-NSSAI Single Network Slice Selection Assistance Information
TAI Tracking Area Identity
TLTRI T8 Long Term Transaction Reference ID
WB Wide Band
YAML YAML Ain't Markup Language

### ** 2nd Change***

### 5.5.2.1.1 Introduction

This clause defines data structures to be used in resource representations.

Table 5.5.2.1.1-1 specifies data types re-used by the ChargeableParty API from other specifications, including a reference to their respective specifications and when needed, a short description of their use within the ChargeableParty API.

TABLE 5.5.2.1.1-1
ChargeableParty API re-used Data Types

| Data type | Reference | Comments |
|---|---|---|
| Dnn | 3GPP TS 29.571 [45] | Identifies a DNN. |
| EthFlowDescription | 3GPP TS 29.514 [52] | Defines a packet filter for an Ethernet flow.(NOTE) |
| MacAddr48 | 3GPP TS 29.571 [45] | MAC Address. |
| ServAuthInfo | 3GPP TS 29.514 [52] | The authorization result of a request bound to a transfer |
| | | policy. |
| Snssai | 3GPP TS 29.571 [45] | Identifies the S-NSSAI. |
| SupportedFeatures | 3GPP TS 29.571 [45] | Used to negotiate the applicability of the optional |
| | | features defined in table 5.5.4-1. |

(NOTE)
In order to support a set of MAC addresses with a specific range in the traffic filter, feature MacAddressRange_5G as specified in clause 5.5.4 shall be supported.

***3rd Change***

### 5.5.2.1.2 Type: ChargeableParty

This type represents the configuration of a chargeable party. The same structure is used in the configuration request and configuration response.

TABLE 5.5.2.1.2-1
Definition of type ChargeableParty

| Attribute name | Data type | Cardinality | Description | Applicability (NOTE 1) |
|---|---|---|---|---|
| self | Link | 0 . . . 1 | Link to the resource “Individual | |
| | | | Chargeable Party Transaction”. This | |
| | | | parameter shall be supplied by the | |
| | | | SCEF in HTTP responses. | |
| dnn | Dnn | 0 . . . 1 | Identifies a DNN, a full DNN with | EthChgParty_{—}5G |
| | | | both the Network Identifier and | |
| | | | Operator Identifier, or a DNN with | |
| | | | the Network Identifier only. | |
| snssai | Snssai | 0 . . . 1 | Identifies an S-NSSAI. | EthChgParty_{—}5G |
| supportedFeatures | SupportedFeatures | 0 . . . 1 | Used to negotiate the supported | |
| | | | optional features of the API as | |
| | | | described in subclause 5.2.7. | |
| | | | This attribute shall be provided in the | |
| | | | POST request and in the response of | |
| | | | successful resource creation. | |
| notificationDestination | Link | 1 | Contains the URI to receive the | |
| | | | notification of bearer level event(s) | |
| | | | from the SCEF. | |
| requestTestNotification | boolean | 0 . . . 1 | Set to true by the SCS/AS to request | Notification_test_event |
| | | | the SCEF to send a test notification as | |
| | | | defined in subclause 5.2.5.3. Set to | |
| | | | false or omitted otherwise. | |
| websockNotifConfig | WebsockNotifConfig | 0 . . . 1 | Configuration parameters to set up | Notification_websocket |
| | | | notification delivery over Websocket | |
| | | | protocol as defined in | |
| | | | subclause 5.2.5.4. | |
| ipv4Addr | Ipv4Addr | 0 . . . 1 | Identifies the Ipv4 address. | |
| | | | (NOTE 2) | |
| ipDomain | string | 0 . . . 1 | The IPv4 address domain identifier. | |
| | | | The attribute may only be provided if | |
| | | | the ipv4Addr attribute is present. | |
| ipv6Addr | Ipv6Addr | 0 . . . 1 | Identifies the Ipv6 address. | |
| | | | (NOTE 2) | |
| macAddr | MacAddr48 | 0 . . . 1 | Identifies the MAC address. | EthChgParty_5G |
| | | | (NOTE 2) | |
| flowInfo | array(FlowInfo) | 0 . . . N | Describes the IP flows. | |
| | | | (NOTE 2) | |
| ethFlowInfo | array(EthFlowDescription) | 0 . . . N | Identifies Ethernet packet flows. | EthChgParty_5G |
| | | | (NOTE 2) | |
| sponsorInformation | SponsorInformation | 1 | Describes the sponsor information | |
| | | | such as who is sponsoring the traffic. | |
| sponsoringEnabled | boolean | 1 | Indicates sponsoring status. | |
| referenceId | BdtReferenceId | 0 . . . 1 | The reference ID for a previously | |
| | | | selected policy of background data | |
| | | | transfer. | |
| servAuthInfo | ServAuthInfo | 0 . . . 1 | Indicates the authorization result for | |
| | | | the request bound to the transfer | |
| | | | policy indicated by the “referenceId” | |
| | | | attribute. | |
| | | | Supplied by the SCEF | |
| usageThreshold | UsageThreshold | 0 . . . 1 | Time period and/or traffic volume. | |

(NOTE 1):
Properties marked with a feature as defined in subclause 5.5.4 are applicable as described in subclause 5.2.7. If no feature are indicated, the related property applies for all the features.
(NOTE 2):
One of ipv4, ipv6 or MAC address shall be provided. If ipv4 or ipv6 address is provided, IP flow information shall be provided. If MAC address is provided, Ethernet flow information shall be provided.

### ***End of Changes***

Modifications on External Group ID in ChargeableParty API in 3GPP TS 29.122 v17.0.0

### ** 1st Change***

### 5.5.2.1.2 Type: ChargeableParty

This type represents the configuration of a chargeable party. The same structure is used in the configuration request and configuration response.

TABLE 5.5.2.1.2-1
Definition of type ChargeableParty

| Attribute name | Data type | Cardinality | Description | Applicability (NOTE 1) |
|---|---|---|---|---|
| self | Link | 0 . . . 1 | Link to the resource “Individual | |
| | | | Chargeable Party Transaction”. This | |
| | | | parameter shall be supplied by the | |
| | | | SCEF in HTTP responses. | |
| externalGroupId | ExternalGroupId | 0 . . . 1 | Identifies a user group. For a Create | EthChgParty_{—}5G |
| | | | request associated with a 5G VN | ExternalGroupId_{—}5G |
| | | | group, the External Group ID | |
| | | | identifies the 5G VN Group. | |
| supportedFeatures | SupportedFeatures | 0 . . . 1 | Used to negotiate the supported optional | |
| | | | features of the API as described in | |
| | | | subclause 5.2.7. | |
| | | | This attribute shall be provided in the | |
| | | | POST request and in the response of | |
| | | | successful resource creation. | |
| notificationDestination | Link | 1 | Contains the URI to receive the | |
| | | | notification of bearer level event(s) from | |
| | | | the SCEF. | |
| requestTestNotification | boolean | 0 . . . 1 | Set to true by the SCS/AS to request the | Notification_test_event |
| | | | SCEF to send a test notification as | |
| | | | defined in subclause 5.2.5.3. Set to false | |
| | | | or omitted otherwise. | |
| websockNotifConfig | WebsockNotifConfig | 0 . . . 1 | Configuration parameters to set up | Notification_websocket |
| | | | notification delivery over Websocket | |
| | | | protocol as defined in subclause 5.2.5.4. | |
| ipv4Addr | Ipv4Addr | 0 . . . 1 | Identifies the Ipv4 address. | |
| | | | (NOTE 2) | |
| ipDomain | string | 0 . . . 1 | The IPv4 address domain identifier. | |
| | | | The attribute may only be provided if the | |
| | | | ipv4Addr attribute is present. | |
| ipv6Addr | Ipv6Addr | 0 . . . 1 | Identifies the Ipv6 address. | |
| | | | (NOTE 2) | |
| macAddr | MacAddr48 | 0 . . . 1 | Identifies the MAC address. | EthChgParty_5G |
| | | | (NOTE 2) | |
| flowInfo | array(FlowInfo) | 0 . . . N | Describes the IP flows. | |
| | | | (NOTE 2) | |
| ethFlowInfo | array(EthFlowDescription) | 0 . . . N | Identifies Ethernet packet flows. | EthChgParty_5G |
| | | | (NOTE 2) | |
| sponsorInformation | SponsorInformation | 1 | Describes the sponsor information such | |
| | | | as who is sponsoring the traffic. | |
| sponsoringEnabled | boolean | 1 | Indicates sponsoring status. | |
| referenceId | BdtReferenceId | 0 . . . 1 | The reference ID for a previously | |
| | | | selected policy of background data | |
| | | | transfer. | |
| servAuthInfo | ServAuthInfo | 0 . . . 1 | Indicates the authorization result for the | |
| | | | request bound to the transfer policy | |
| | | | indicated by the “referenceId” attribute. | |
| | | | Supplied by the SCEF | |
| usageThreshold | UsageThreshold | 0 . . . 1 | Time period and/or traffic volume. | |

(NOTE 1):
Properties marked with a feature as defined in subclause 5.5.4 are applicable as described in subclause 5.2.7. If no feature are indicated, the related property applies for all the features.
(NOTE 2):
One of ipv4, ipv6 or MAC address shall be provided. If ipv4 or ipv6 address is provided, IP flow information shall be provided. If MAC address is provided, Ethernet flow information shall be provided.

***2nd Change***

### 5.5.4 Used Features

The table below defines the features applicable to the ChargeableParty API. Those features are negotiated as described in subclause 5.2.7.

TABLE 5.5.4-1
Features used by ChargeableParty API

| Feature | | |
|---|---|---|
| Number | Feature | Description |
| 1 | Notification_websocket | The delivery of notifications over Websocket is supported |
| | | according to subclause 5.2.5.4. This feature requires that the |
| | | Notification_test_event feature is also supported. |
| 2 | Notification_test_event | The testing of notification connection is supported according to |
| | | subclause 5.2.5.3. |
| 3 | EthChgParty_5G | Chargeable Party for Ethernet UE. This feature may only be |
| | | supported in 5G. |
| 4 | MacAddressRange_5G | Indicates the support of a set of MAC addresses with a specific |
| | | range in the traffic filter. This feature may only be supported in |
| | | 5G. |
| 5 | ExternalGroupId_{—}5G | Indicates the support of the External Group ID. Identifies a |
| | | user group. For a Create request associated with a 5G VN |
| | | group, the External Group ID identifies the 5G VN Group. |
| | | This feature may only be supported in 5G. |

Feature: A short name that can be used to refer to the bit and to the feature, e.g. “Notification”.
Description: A clear textual description of the feature.

### ***End of Changes***

The exemplary procedure as shown in FIG. 6 also relates to modifications on e.g., following sections in 3GPP TS 29.522 v17.0.0, which are shown in Bold.
Modifications on DNN and S-NSSAI in ChargeableParty API procedure in 3GPP TS 29.522 v17.0.0
   ***1st Change***

### 4.4.8 Procedures for Changing the Chargeable Party at Session Set Up or During the Session

The procedures for changing the chargeable party at session set up or during the session in 5GS are described in subclause 4.4.4 of 3GPP TS 29.122 [4] with the following differences:
description of the SCS/AS applies to the AF;
description of the SCEF applies to the NEF;
description of the PCRF applies to the PCF;
if the EthChgParty_5G feature as defined in subclause 5.5.4 of 3GPP TS 29.122 [4] is supported and the request is for Ethernet UE:
   in the HTTP POST request, the AF shall include the UE MAC address within the “macAddr” attribute instead of the UE IP address and the Ethernet Flow description within the “ethFlowInfo” attribute instead of the IP Flow description; the AF may include the Ethernet UE corresponding “dnn” attribute and/or “snssai” attribute;
   in the HTTP PATCH request, the AF may update the Ethernet Flow description within the “ethFlowInfo” attribute;
the NEF may interact with BSF by using Nbsf_Management_Discovery service (as defined in 3GPP TS 29.521 [9]) to retrieve the PCF address; and
the NEF shall interact with the PCF by using Npcf_PolicyAuthorization service as defined in 3GPP TS 29.514 [7].

### ***End of Changes***

Modifications on External Group ID in ChargeableParty API procedure in 3GPP TS 29.522 v17.0.0
   ***1st Change***

### 4.4.8 Procedures for Changing the Chargeable Party at Session Set Up or During the Session

The procedures for changing the chargeable party at session set up or during the session in 5GS are described in subclause 4.4.4 of 3GPP TS 29.122 [4] with the following differences:
description of the SCS/AS applies to the AF;
description of the SCEF applies to the NEF;
description of the PCRF applies to the PCF;
if the EthChgParty_5G feature as defined in subclause 5.5.4 of 3GPP TS 29.122 [4] is supported and the request is for Ethernet UE:
   in the HTTP POST request, the AF shall include the UE MAC address within the “macAddr” attribute instead of the UE IP address and the Ethernet Flow description within the “ethFlowInfo” attribute instead of the IP Flow description;
   in the HTTP POST request, the AF may include the Ethernet UE corresponding “externalGroupId” attribute, if the ExternalGroupId_5G feature is also supported.
   in the HTTP PATCH request, the AF may update the Ethernet Flow description within the “ethFlowInfo” attribute;
the NEF may interact with BSF by using Nbsf_Management_Discovery service (as defined in 3GPP TS 29.521 [9]) to retrieve the PCF address; and
the NEF shall interact with the PCF by using Npcf_PolicyAuthorization service as defined in 3GPP TS 29.514 [7].

### ***End of Changes***

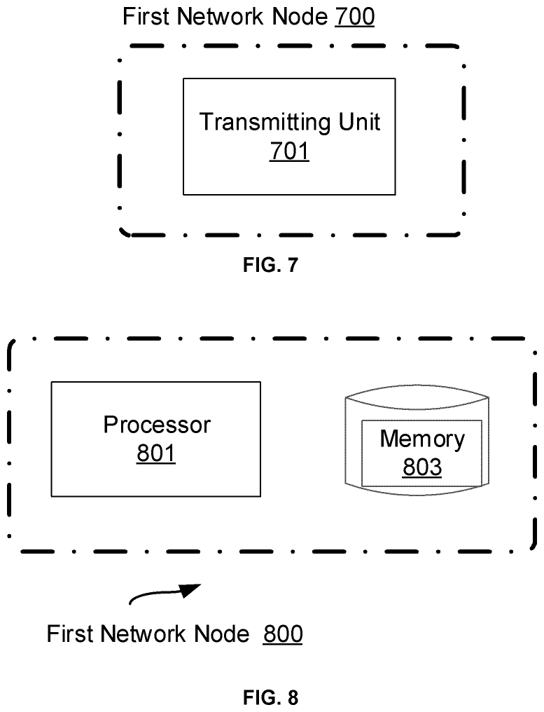

Hereinafter, a structure of a first network node according to an exemplary embodiment of the present disclosure will be described with reference to FIG. 7. FIG. 7 schematically shows a block diagram of a first network node 700 according to an exemplary embodiment of the present disclosure. The first network node 700 in FIG. 7 may perform the method 200 as described previously with reference to FIG. 2. Accordingly, some detailed description on the first network node 700 may refer to the corresponding description of the method 200 in FIG. 2 and the signaling sequence diagrams of FIGS. 4 and 5 as previously discussed, and thus will be omitted here for simplicity.

As shown in FIG. 7, the first network node 700 may include a transmitting unit 701, which may be configured to transmit a service request message for the Ethernet type session to the second network node, wherein the service request message comprises network related identification information for the Ethernet type session.

In an exemplary embodiment, the network related identification information for the Ethernet type session is preconfigured in the AF or dynamically provided.

In an exemplary embodiment, the network related identification information for the Ethernet type session includes at least one of:
a DNN for the Ethernet type session; and
an S-NSSAI for the Ethernet type session.

In an exemplary embodiment, the network related identification information for the Ethernet type session includes an external group ID of a virtual network for the Ethernet type session, which is associated with at least one of:
a DNN for the Ethernet type session; and
an S-NSSAI for the Ethernet type session.

In an exemplary embodiment, the external group ID indicates support of the first network node for at least one of:
an external group ID feature,
an Ethernet application server session QoS feature, and
an Ethernet chargeable party feature.

In an exemplary embodiment, the service request message further includes a UE MAC address for a UE associated with the Ethernet type session.

In an exemplary embodiment, the first network node 700 may further include: a receiving unit, which may be configured to receive, from the second network node, a response indicating whether a requested service is successfully invoked for the Ethernet type session or not.

In an exemplary embodiment, the first network node is an AF; the second network node is an NEF; and the third network node is a PCF.

In an exemplary embodiment, the service request message includes at least one of:
a request message for managing required QoS for a service data flow of the Ethernet type session; and
a request message for managing a chargeable party for the Ethernet type session.

Hereinafter, a structure of a first network node according to another exemplary embodiment of the present disclosure will be described with reference to FIG. 8. FIG. 8 schematically shows a block diagram of a first network node 800 according to an exemplary embodiment of the present disclosure. The first network node 800 in FIG. 8 may perform the method 200 as described previously with reference to FIG. 2. Accordingly, some detailed description on the first network node 800 may refer to the corresponding description of the method 200 in FIG. 2 and the signaling sequence diagrams of FIGS. 4 and 5 as previously discussed, and thus will be omitted here for simplicity.

As shown in FIG. 8, the first network node 800 includes at least one processor 801 and at least one memory 803. The at least one processor 801 includes e.g., any suitable CPU (Central Processing Unit), microcontroller, DSP (Digital Signal Processor), etc., capable of executing computer program instructions. The at least one memory 803 may be any combination of a RAM (Random Access Memory) and a ROM (Read Only Memory). The at least one processor memory 803 may also include persistent storage, which, for example, can be any single one or combination of magnetic memory, optical memory, or solid state memory or even remotely mounted memory.

The at least one memory 803 stores instructions executable by the at least one processor 801. The instructions, when loaded from the at least one memory 803 and executed on the at least one processor 801, may cause the first network node 800 to perform the actions, e.g., of the procedures as described earlier respectively in conjunction with FIG. 2 with reference to the signaling sequence diagrams of FIGS. 4 and 5 as previously discussed, and thus will be omitted here for simplicity.

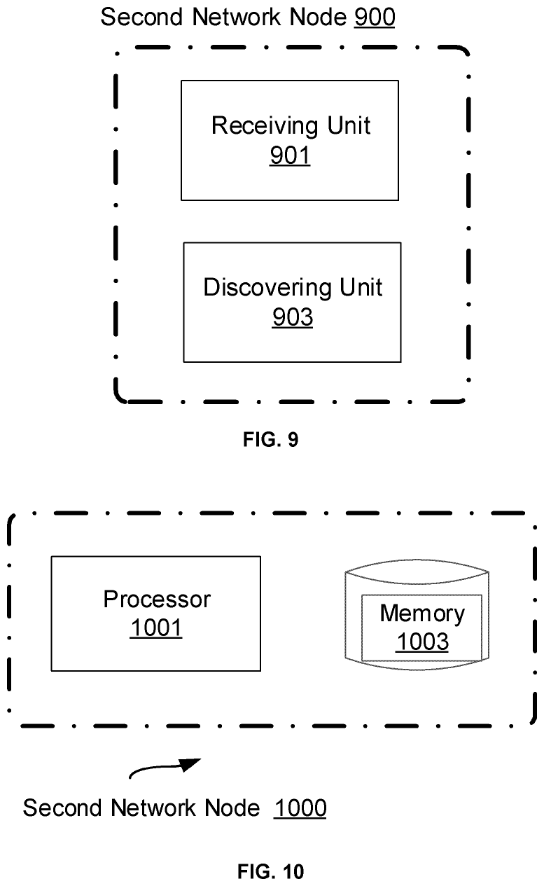

Hereinafter, a structure of a second network node according to an exemplary embodiment of the present disclosure will be described with reference to FIG. 9. FIG. 9 schematically shows a block diagram of a second network node 900 according to an exemplary embodiment of the present disclosure. The second network node 900 in FIG. 9 may perform the method 300 as described previously with reference to FIG. 3. Accordingly, some detailed description on the second network node 900 may refer to the corresponding description of the method 300 in FIG. 3 and the signaling sequence diagrams of FIGS. 6 and 5 as previously discussed, and thus will be omitted here for simplicity.

As shown in FIG. 9, the second network node 900 may include a receiving unit 901 and a discovering unit 903.

The receiving unit 901 may be configured to receive a service request message for the Ethernet type session from a first network node, wherein the service request message includes network related identification information for the Ethernet type session.

The discovering unit 903 may be configured to discover the third network node at least based on the network related identification information.

In an exemplary embodiment, the service request message further includes a UE MAC address of a UE associated with the Ethernet type session.

Alternatively, the discovering unit 903 may be configured to discover, based on the network related identification information, a fifth network node that holds binding information of the third network node for the Ethernet type session; and discover the third network node using the UE MAC address received from the AF by querying the fifth network node.

In an exemplary embodiment, the network related identification information for the Ethernet type session is preconfigured or dynamically provided.

In an exemplary embodiment, the network related identification information for the Ethernet type session includes at least one of:
a DNN for the Ethernet type session; and
an S-NSSAI for the Ethernet type session.

In an exemplary embodiment, the network related identification information for the Ethernet type session includes an external group ID of a virtual network for the Ethernet type session, which is associated with at least one of:
a DNN for the Ethernet type session; and
an S-NSSAI for the Ethernet type session.

In an exemplary embodiment, the external group ID indicates support of the first network node for at least one of:
an external group ID feature,
an Ethernet application server session QoS feature, and
an Ethernet chargeable party feature.

In an exemplary embodiment, the second network node 900 may further include a derivation unit (not shown), which may be configured to derive the at least one of the DNN for the Ethernet type session and the S-NSSAI for the Ethernet type session from the external group ID.

In an exemplary embodiment, the derivation unit may be further configured to query a fourth network node, that stores an association relationship between an external group ID and an DNN and/or S-NSSAI, for the at least one of the DNN for the Ethernet type session and the S-NSSAI for the Ethernet type session, using the external group ID.

In an exemplary embodiment, the discovering unit 903 may be further configured to discover, based on the at least one of the DNN for the Ethernet type session and the S-NSSAI for the Ethernet type session, a fifth network node that holds binding information of the third network node for the Ethernet type session; and query the fifth network node using the UE MAC address and the at least one of the DNN for the Ethernet type session and the S-NSSAI for the Ethernet type session to discover the third network node.

In an exemplary embodiment, the fifth network node is discovered by the second network node querying a sixth network node using the at least one of the DNN for the Ethernet type session and the S-NSSAI for the Ethernet type session.

In an exemplary embodiment, the second network node 900 may further include a transmitting unit (not shown), which may be configured to transmit, to the third network node, another service request message to invoke a requested service for the Ethernet type session. And the receiving unit 901 may be further configured to receive, from the third network node, a response indicating whether the requested service is successfully invoked for the Ethernet type session or not.

In an exemplary embodiment, the first network node is an AF; the second network node is an NEF; the third network node is a PCF; the fourth network node is a UDM; the fifth network node is a BSF; and the sixth network node is an NRF.

In an exemplary embodiment, the service request message includes a request message for managing required QoS for a service data flow of the Ethernet type session, and is received via an Nnef_AFsessionWithQoS API.

In an exemplary embodiment, the service request message includes a request message for managing a chargeable party for the Ethernet type session, and is received via an Nnef_ChargeableParty API.

Hereinafter, a structure of a second network node according to another exemplary embodiment of the present disclosure will be described with reference to FIG. 10. FIG. 10 schematically shows a block diagram of a second network node 1000 according to an exemplary embodiment of the present disclosure. The second network node 1000 in FIG. 10 may perform the method 300 as described previously with reference to FIG. 3. Accordingly, some detailed description on the second network node 1000 may refer to the corresponding description of the method 300 in FIG. 3 and the signaling sequence diagrams of FIGS. 6 and 5 as previously discussed, and thus will be omitted here for simplicity.

As shown in FIG. 10, the second network node 1000 includes at least one processor 1001 and at least one memory 1003. The at least one processor 1001 includes e.g., any suitable CPU (Central Processing Unit), microcontroller, DSP (Digital Signal Processor), etc., capable of executing computer program instructions. The at least one memory 1003 may be any combination of a RAM (Random Access Memory) and a ROM (Read Only Memory). The at least one processor memory 1003 may also include persistent storage, which, for example, can be any single one or combination of magnetic memory, optical memory, or solid state memory or even remotely mounted memory.

The at least one memory 1003 stores instructions executable by the at least one processor 1001. The instructions, when loaded from the at least one memory 1003 and executed on the at least one processor 1001, may cause the second network node 1000 to perform the actions, e.g., of the procedures as described earlier respectively in conjunction with FIG. 3 with reference to the signaling sequence diagrams of FIGS. 6 and 5 as previously discussed, and thus will be omitted here for simplicity.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program.

The computer program includes: code/computer readable instructions, which when executed by the at least one processor 801 causes the first network node 800 to perform the actions, e.g., of the procedure described earlier in conjunction with FIG. 2; or code/computer readable instructions, which when executed by the at least one processor 1001 causes the second network node 1000 to perform the actions, e.g., of the procedures described earlier respectively in conjunction with FIG. 3.

The computer program product may be configured as a computer program code structured in computer program modules. The computer program modules could essentially perform the actions of the flow illustrated in any of FIGS. 2 to 6.

The processor may be a single CPU (Central processing unit), but could also include two or more processing units. For example, the processor may include general purpose microprocessors; instruction set processors and/or related chips sets and/or special purpose microprocessors such as Application Specific Integrated Circuit (ASICs). The processor may also include board memory for caching purposes. The computer program may be carried by a computer program product connected to the processor. The computer program product may include a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

The present disclosure has been described above with reference to embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached.

1-22. (canceled)

23. A method at an Application Function (AF) for facilitating a Network Exposure Function (NEF) in a core network to dynamically discover a Policy Control Function (PCF) serving an Ethernet type session, the method comprising:
transmitting a service request message for the Ethernet type session to the NEF, wherein the service request message comprises network related identification information for the Ethernet type session.

24. The method of claim 23, wherein the network related identification information for the Ethernet type session is preconfigured in the AF or dynamically provided.

25. The method of claim 23, wherein the network related identification information for the Ethernet type session comprises at least one of:
a Data Network Name (DNN) for the Ethernet type session; and
a Single-Network Slice Selection Assistance Information (S-NSSAI) for the Ethernet type session.

26. The method of claim 23, wherein the service request message further comprises a User Equipment (UE) Media Access Address (MAC) address for a UE associated with the Ethernet type session.

27. The method of claim 23, further comprising:
receiving, from the NEF, a response indicating whether a requested service is successfully invoked for the Ethernet type session.

28. The method of claim 23, wherein the service request message comprises at least one of:
a request message for managing required Quality of Service (QoS) for a service data flow of the Ethernet type session; and
a request message for managing a chargeable party for the Ethernet type session.

29. A method at a Network Exposure Function (NEF) in a core network for dynamically discovering a Policy Control Function (PCF) for an Ethernet type session, the method comprising:
receiving a service request message for the Ethernet type session from an Application Function (AF), wherein the service request message comprises network related identification information for the Ethernet type session; and
discovering, based on the network related identification information, a Binding Support Function (BSF) that holds binding information of the PCF for the Ethernet type session.

30. The method of claim 29, wherein the service request message further comprises a User Equipment (UE) Media Access Address (MAC) address of a UE associated with the Ethernet type session.

31. The method of claim 30, further comprising:
discovering the PCF using the UE MAC address received from the AF by querying the BSF.

32. The method of claim 29, further comprising: discovering the PCF based on the network related identification information.

33. The method of claim 29, wherein the network related identification information for the Ethernet type session is preconfigured in the AF or dynamically provided to the AF.

34. The method of claim 29, wherein the network related identification information for the Ethernet type session comprises at least one of:
a Data Network Name (DNN) for the Ethernet type session; and
a Single-Network Slice Selection Assistance Information (S-NSSAI) for the Ethernet type session.

35. The method of claim 29, wherein
the BSF is discovered by the NEF querying a Network Repository Function (NRF) using the at least one of the DNN for the Ethernet type session and the S-NSSAI for the Ethernet type session.

36. The method of claim 29, further comprising:
transmitting, to the PCF, another service request message to invoke a requested service for the Ethernet type session; and
receiving, from the PCF, a response indicating whether the requested service is successfully invoked for the Ethernet type session.

37. The method of claim 29, wherein
the service request message comprises a request message for managing required Quality of Service (QoS) for a service data flow of the Ethernet type session, and is received via an Nnef_AFsessionWithQoS Application Programming Interface (API′.

38. The method of claim 29, wherein
the service request message comprises a request message for managing a chargeable party for the Ethernet type session, and is received via an Nnef_ChargeableParty API.

39. An Application Function (AF), comprising:
at least one processor, and
at least one memory, storing instructions which, when executed on the at least one processor, cause the AF to:
transmit a service request message for the Ethernet type session to a Network Exposure Function (NEF), wherein the service request message comprises network related identification information for the Ethernet type session.

40. A Network Exposure Function (NEF), comprising:
at least one processor, and
at least one memory, storing instructions which, when executed on the at least one processor, cause the NEF to:
receive a service request message for the Ethernet type session from an Application Function (AF), wherein the service request message comprises network related identification information for the Ethernet type session; and
discover, based on the network related identification information, a Binding Support Function (BSF) that holds binding information of a Policy Control Function (PCF) for the Ethernet type session.
